(19) United States
(12) Patent Application Publication
(10) Pub. No.: US 2005/0027991 A1
(43) Pub. Date: Feb. 3, 2005

(54) System and method for digital rights management

(76) Inventor: Joseph DiFonzo, Sanford, FL (US)

Correspondence Address: Frost Brown Todd LLC, 2200 PNC Center, 201 East Fifth Street, Cincinnati, OH, 45202, US

(21) Appl. No.: 10/874,712

(22) Filed: Jun. 23, 2004

Related U.S. Application Data
(60) Provisional application No. 60/480,821, filed on Jun. 23, 2003.

(51) Int. Cl. H04L 9/00

(52) U.S. Cl. 713/185

(57) ABSTRACT

The invention provides several embodiments of a system and method of securely distributing and using digital content that protects the content owner's copyrights as well as the content user's right of fair use. Digital content may be any work that can be encoded in digital form, e.g. literature, music, software applications, static images, and video, etc. Various embodiments act by implementing public key infrastructure to encrypt digital content in such a way that only a licensed user may access the content. Embodiments enable licensed users to access the content via multiple playback devices and from various locations, regardless of whether they are connected to a publicly accessible, traditional MAN or WAN.

This is a Non-Provisional Patent Application, which claims priority from U.S. Provisional Application No. 60/480,821, filed on Jun. 23, 2003, which is incorporated by reference herein.

### BACKGROUND OF THE INVENTION

This invention is in the field of digital rights management (DRM) systems. Digital content (books, music, software, etc.) providers want to sell their wares while adequately protecting their copyrights. Customers want to purchase the content and need proper authorizations to use the content in a fair and legal manner.

Current DRM Models do not protect digital content adequately because they do not provide sufficient security to prevent computer hackers from accessing copyrighted content. Current DRM Models are too restrictive to the consumer because they only allow access to content when connected to a traditional MAN or WAN, do not allow copies for personal use, and are often too difficult for the average consumer to understand. Current DRM Models are further limited because they often lock to a specific piece of hardware, do not allow content to be transferred to different mediums, and deviate from standard business models.

To remedy the inadequacies of current DRM Models, a digital rights management system would preferably including one or more of the following functionalities:

1. Provide access to content without a network connection;

2. Permit content usage from multiple devices or locations;

3. Allow consumers without complex technical knowledge or skills to access and manage content;

4. Follow accepted business practices (i.e., pay to play);

5. Allow consumers to remain anonymous;

6. Keep additions to the costs of content minimal;

7. Allow rights to be transferred among consumers;

8. Permit content transfer to multiple mediums; and

9. Remain unobtrusive or even invisible.

### BRIEF SUMMARY OF THE INVENTION

Various embodiments of the invention may be designed to securely distribute and use digital content in a manner that protects the content owner's copyrights as well as the content user's right of fair use. Digital content may be any work that can be encoded in digital form, such as literature, music, software applications, static images, and video, etc. Various embodiments secure digital rights by encrypting the digital content in such a way (i.e., via public key infrastructure (PKI)) that only a licensed user may access the content. The licensed user may, however, access the content from any playback device and from any location.

Public key infrastructure (PKI) may enable users of an unsecure public network to securely and privately exchange data and money through the use of a public and a private cryptographic key pair that is obtained and shared through a trusted authority. The public key infrastructure may provide for a digital certificate that can identify an individual or an organization and directory services that can store and, when necessary, revoke the certificate.

The system may allow access to the content when the user is not connected to a network. The network may be a traditional, publicly accessible wide area network (WAN), which may be any geographically dispersed telecommunications network, such as the Internet. The WAN may be privately owned or rented, but the term usually connotes the inclusion of public (shared user) networks. Alternatively, the network may be an intermediate form of network, a metropolitan area network (MAN), that interconnects users with computer resources in a particular geographic area or region. WANs and MANs provide a broader telecommunication structure than local area networks (LAN), which typically consist of a single group of computers and associated devices that share a common communications line or wireless link and share the resources of a single processor or server within a small geographic area (e.g., within an office building).

The system may allow a licensed user to copy the content to different media types (e.g., compact discs (CDs), digital video discs (DVDs), and memory cards), and may ensure that only the licensed user has access to the copies. Finally, the system may take advantage of developments in short distance communication technology (i.e., Bluetooth wireless communication) to simplify and enhance the user experience.

Ideally, the system may allow access to any content, regardless of whether the user is connected to a traditional WAN or MAN. If, for example, a user downloaded a song and wanted to play it in his or her car, then the system would still provide access to the song from the car, despite the absence of a traditional WAN or MAN connection.

The system may also allow content usage from multiple devices and locations. For instance, a content file that has been downloaded onto a computer may also be played on the user's high-end stereo or in the user's car radio player. Preferably, the system would not require the consumer to possess any complex technical knowledge or skills to operate the system or access digital content.

Optimally, the system may allow rights to be transferred among consumers via any medium. For example, the user may take the content, download it from a traditional MAN or WAN (e.g., the Internet), store it on a hard disk, move it to a CD, move it to a DVD, move it to a memory stick, etc. It may, preferably, be unobtrusive and invisible such that it does not interfere with content purchase or playback.

Various embodiments may combine existing technologies (i.e., PKI, Bluetooth, smart cards) to provide an end-to-end model for content purchasing and usage. Most other DRM schemes are tied to a particular playback device (e.g., computer), or require the user to be on the Internet to validate rights. Other commercially available DRM schemes do not use smart cards to secure access to content, nor do they use wireless communications technology (e.g., Bluetooth radio) to validate licensed users before opening the content.

The system for securing digital content may comprise a smart chip/card, an authentication device, a playback device, and an encrypted content file. A smart chip may be a microchip, which may be embedded into a card or authentication device. The smart chip may be loaded with data and may transfer the data to and from a playback device. Smart chips may come in various capacities. Some smart chips may have the capability to store vast amounts of data, while some may only hold the public and private keys for the chip and the public keys for the valid playback devices. A smart card may be a plastic card about the size of a credit card, with an embedded microchip that can be loaded with data, used for telephone calling, electronic cash payments, and other applications, and then periodically refreshed for additional use.

An authentication device may be any machine capable of verifying the identity of a user or verifying a user's rights to digital content. A playback device may be any machine or mechanism that is capable of reading or accessing digital content and transmitting the content to the user. Examples of playback devices include, but are not limited to, CD players, DVD players, smart card readers, memory card readers, personal computers (PCs), portable digital assistants (PDA's), MP3 players, and the like. An encrypted content file may be an entity of digital data that has been transformed into a format that is difficult to interpret as a mechanism for protecting its confidentiality, integrity and/or authenticity.

The smart chip/card may hold a set of personal encryption keys, including a public key and a private key. The set of personal encryption keys may include one or more public key and private key pairs. The public key may consist of a string of bits that is published. The private key may consist of a string of bits that is known only to the user. Collectively, the public key and the private key may be used to effectively encrypt digital content.

In public key cryptography, a public and private key are created simultaneously using the same algorithm by a certificate authority (CA). The private key is given only to the requesting party and the public key is made publicly available (as part of a digital certificate) in a directory that all parties can access. The private key is never shared with anyone or sent across the traditional WAN or MAN. A user may utilize the private key to decrypt text that has been encrypted with the user's public key by someone else (who can find out what your public key is from a public directory).

The encrypted content file may be at least partially encrypted with the public key of the set of personal encryption keys. The authentication device may be configured to hold the smart chip and permit the smart chip to interface with the playback device. The playback device may be configured to receive the encrypted content file, detect the authentication device, electronically communicate with the smart chip, within a predefined communication range, decrypt the encrypted content file using the private key, and play the content file on the playback device.

The encrypted content file may comprise digital content, which may consist of a work encoded in digital form. The digital content may be literature, music, software applications static images, video, and any combination thereof.

In one embodiment, the smart chip/card may also include a digital certificate. In these embodiments, a content provider may authorize the smart chip by validating the digital certificate.

The authentication device may be a portable device. The playback device may be further configured to verify the proximity of a user by determining whether the authentication device is within the predefined communication range.

In some embodiments, the encrypted content file may be written to a plurality of mediums. The plurality of mediums may include compact discs, digital video discs, memory sticks, memory cards, hard disks, and hard drives. In other embodiments, the encrypted content file may be received and played by a plurality of playback devices.

Embodiments may further incorporate a point-of-sale device. The authentication device may be configured to permit the smart chip to interface with the point-of-sale device.

Methods for securely distributing and using digital content in accordance with the invention may include the steps of: installing a set of personal encryption keys, including a public key and a private key, onto a smart chip; inserting the smart chip into an authentication device configured to permit the smart chip to interface with a playback device; creating an encrypted content file by encrypting a piece of digital content with a random content key; encrypting the random content key with the smart chip's public key such that the random content key may only be decrypted by the smart chip's private key; and configuring the playback device to communicate with the authentication device to decrypt the encrypted content file. The random content key may be an automatically generated string of random letters and numbers.

Embodiments may also include the steps of configuring the playback device to electronically communicate with the smart chip within a predefined communication range and configuring the playback device to verify the proximity of a user by determining whether the authentication device is within the predefined communication range.

Other embodiments may effect secure purchase and use of digital content. These methods may include the steps of: installing a set of personal encryption keys, including a public key and a private key, onto a smart chip; inserting the smart chip into an authentication device configured to permit the smart chip to interface with a playback device; allowing a user possessing the smart chip to interact with a point-of-sale device and select a piece of digital content; configuring the point-of-sale device to transmit the user's selection to a content provider; the content provider encrypting the piece of digital content with a random content key and encrypting the random content key with the smart card's public key such that the random content key may only be decrypted by the smart card's private key; and storing the piece of digital content on a storage medium. A storage medium may be any technology (including devices and materials) used to place, keep, and retrieve data on a long-term basis.

The smart chip may include a digital certificate. The content provider may authorize the smart chip by validating the digital certificate.

Embodiments may also comprise a computer readable medium having computer executable instructions for performing a method. The method may include the step of initiating communication between an authentication device and a playback device having a set of personal encryption keys, including a public key and a private key. The method may further encompass configuring the authentication device to decrypt a random content key and re-encrypt the random content key with the playback device's public key. The method may further include the step of configuring the playback device to decrypt the random content key with the playback device's private key and utilize the random content key to decrypt an encrypted content file.

### BRIEF DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers.

FIG. 1 illustrates one embodiment of the smart chip of the DRM system.

FIG. 2 illustrates one embodiment of the authentication device of the DRM system.

FIG. 3 illustrates one embodiment of a point-of-sale kiosk, which may interact with the DRM system.

FIG. 4 illustrates a diagram of the interactions associated with a deployment of one embodiment of the DRM system.

FIG. 5 illustrates a diagram of the interactions associated with a deployment of another embodiment of the DRM system.

### DETAILED DESCRIPTION OF THE INVENTION

Various embodiments of the invention may comprise one or more smart chips/cards that may contain unique personal encryption key sets that are used to guard access to digital content. The smart chips/cards may also include encrypt/decrypt functions. The personal encryption key set may include a private key and a public key. The smart chip/card may be embedded or inserted into an authentication device. The authentication device may be a small and inexpensive device that may be attached to a key ring or other common article. The authentication device may permit physical and wireless (i.e., Bluetooth) interfaces with point-of-sale and playback devices. The authentication device may allow communication between the internal device and the smart chip/card. For example, the authentication device may interact with a point-of sale device and a content provider to effect the purchase of content.

Embodiments of the system, method, and apparatus of the present invention securely protect content based on public key cryptography and provide a complete chain of trust from purchase to playback. The system may implement a two-stage encryption process. When consumers purchase digital content, the content provider may encrypt the content with a random content key. Each piece of digital content may have its own unique random content key (i.e., a different key for each song, book, etc.). In particular, when a user transmits his or her public key to a point-of-sale device, the point-of-sale device may upload the public key to the content provider. The content provider may encrypt the digital content with an automatically generated string of random letters and numbers. After the content provider encrypts the content, the content provider must then encrypt the content key itself to enable the content key to pass across interfaces without interception. The content provider encrypts the content key with the purchaser's (i.e., the user's) public key so that only the purchaser's private key can decrypt the content key to access the content. Thus, only the purchaser's authentication device can decode the content. This enables a method of decryption without ever passing anything over the traditional MAN or WAN that could be used by a hacker and/or unauthorized user to decrypt the content.

The use of a random content key eliminates several potential limitations on security. First, because each piece of content is independently encrypted, hackers and/or unauthorized users may not break the encryption on all content merely by decrypting one piece of content. Second, hackers and/or unauthorized users are deterred from attempting to decrypt content because the encryption patterns are random strings of letters and numbers that cannot logically be determined. Third, the random content key only passes across the interface one time in encrypted form, thus preventing interception of decryption information.

A content playback device may guarantee the security of decrypted content by allowing only licensed users to access the digital content. The playback device may initiate communication with the user's authentication device when the user requests the playback device to play a piece of content. The playback device may request the authentication device to decrypt the content key. The authentication device may then decrypt the content key and re-encrypt the content key using the public key of the playback device so that only the playback device can decrypt the content key. Once the playback device has successfully decrypted the content key, it may use the content key to decrypt, and subsequently, play the content.

Content playback devices may verify the proximity of the user through physical or wireless communication with the authentication device. The authentication device may be equipped with a short distance wireless communication technology, such as Bluetooth or its equivalent. The communication range may be anywhere from virtually no distance, to ten feet, thirty feet, or whatever range the technology is capable of supporting, now or in the future. If the authentication device is not located within the communication range of the playback device, then the playback device will not be able to communicate with the authentication device. Accordingly, the playback device may verify the user's presence because it can detect whether the user is within the communication range.

This feature may facilitate portability because a user may access content from any location, provided that the authentication device is within the specified communication range of the playback device. Thus, if the authentication device is near the user's car stereo player, then when the user gets in the car and turns on the car stereo, the car stereo will be able to playback the content because the decryption device is essentially going to be within the requisite communication range. Similarly, if the authentication device is on the user's key chain, then the user may drop the authentication device on the coffee table and access the content through a playback device that is within the communication range of the authentication device, such as a CD player. This allows for scenarios that are not feasible when the user must physically move files around to places or carry components and devices that have to be physically connected.

In another embodiment users may share content. If, for instance, a user is entertaining, the user's friends may bring over their encrypted content, and as long as they bring their authentication devices with them, they may access their encrypted content in the presence of one another. Thus, users may play their encrypted content for anyone in the room.

Embodiments may also enable the consumer to make as many copies of the content as they wish and employ multiple media types for different copies. The content is a stream of data in a file format. It may be read from or written to any type of media, such as a CD, a DVD, a memory stick, or a personal computer's hard drive. Copying the content does not interfere with the encryption; thus the content may remain secure when a user moves it from one medium to another.

The copying and portability features are possible because the content may be keyed to the smart chip or smart card rather than the playback device. The encrypted content may be keyed to the smart chip/card embedded in the user's authentication device, which moves around with the user. Thus, a user may still access content if one particular copy is ruined (i.e., the user loses a CD or the user's hard drive crashes). Further, the encrypted content can only be decrypted and played when a valid authentication device is within the communication range of the playback device. The authentication device does not require a copy of the content to play the content; it merely needs to be able authorize use of the content on the playback device.

Various embodiments may also permit anonymous consumption because the consumer could potentially never be personally identified. The smart chip/card may be physically or electronically imprinted with a unique identification number. When the user acquires the smart chip/card, the smart chip/card retains the unique identification number, which may not necessarily be related to personally identifying information of the user. This may allow a user to sell or otherwise transfer his or her smart chip and the accompanying content to another user while maintaining protection of the content owner's copyright.

Systems and methods of the present invention may further provide a simple mechanism for the consumer without deviating from standard business practices. Standard business transactions typically allow a user to access content after the user has presented some form of payment. This system adheres to this standard business model because a user may obtain a personal encryption key set that enables access to the content when the user purchases the content or licenses rights to the content from the content provider.

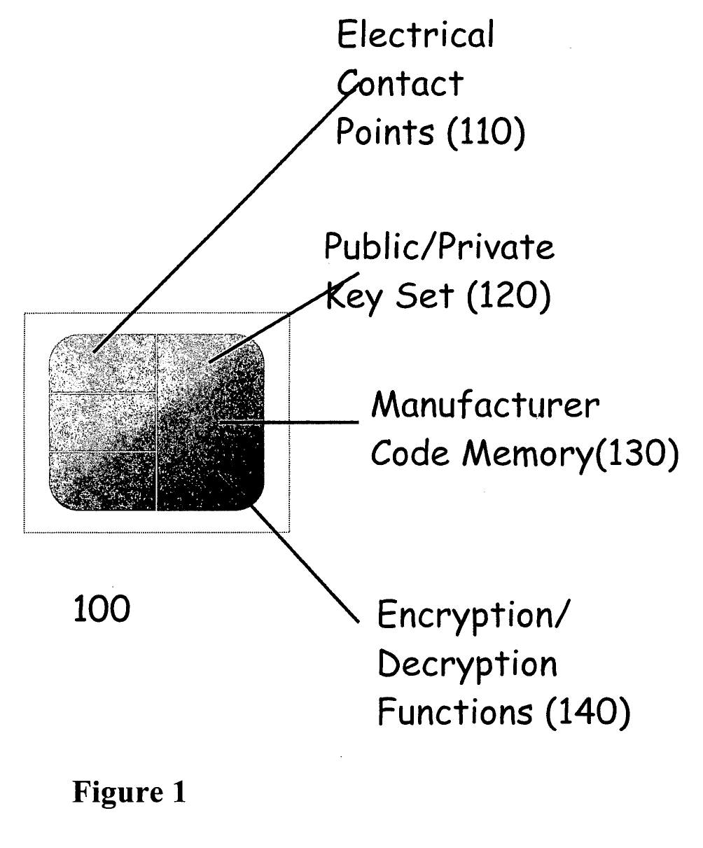

Referring to FIG. 1, in one embodiment a smart chip/card (100) may contain a public/private key set (120) used to encrypt and decrypt (140) content (700). Security features may deter hackers from obtaining the private key. In a preferred but not mandatory embodiment, the smart chip/card (100) may contain no personal information about the consumer. The smart chip/card (100) may store manufacturer codes (130) and public keys. Each smart chip/card (100) may also have a unique serial number to allow replacement if lost or damaged.

Embodiments may be based on public key cryptography (or equivalents thereof) and may provide a complete chain of trust from content purchase to content playback. Thus, hackers are inhibited from accessing the content (700) in raw, un-encrypted form. A physical inspection of a smart chip/card (100) does not reveal the public/private key set (120) used to encrypt and decrypt (140) the content (700). Further, each smart chip/card (100) may be configured to prevent copying. Such anti-copying, anti-hacking techniques are known to those of skill in the art.

The system may further allow anonymous consumption because the consumer never has to be personally identified. The unique smart chip/card (100) identifies the user, which eliminates the need to know the user's personal information. Moreover, it allows portability because users can make copies of the content (700) on any type medium and use them wherever they want as long as they are within range of the authentication device (200).

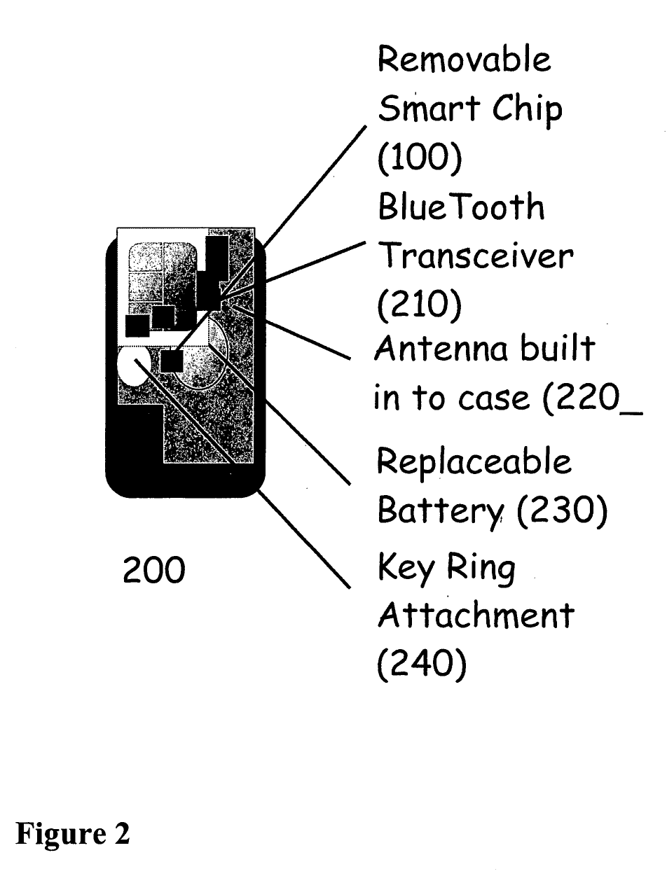

Referring to FIG. 2, the authentication device (200) may be small and inexpensive (possibly a give-away to encourage use of the system, method, and apparatus). Again, it would preferably contain no private information about the consumer. Each part of the authentication device (200) would preferably be replaceable including its battery (or other power source) (230). The smart chip/card (100) may be removable such that if the device is damaged beyond reasonable repair, the smart chip/card (100) may be removed and inserted into another unit. Also, if the smart chip/card (100) is lost or damaged, the serial number may be used to develop a replacement chip/card with the same key set.

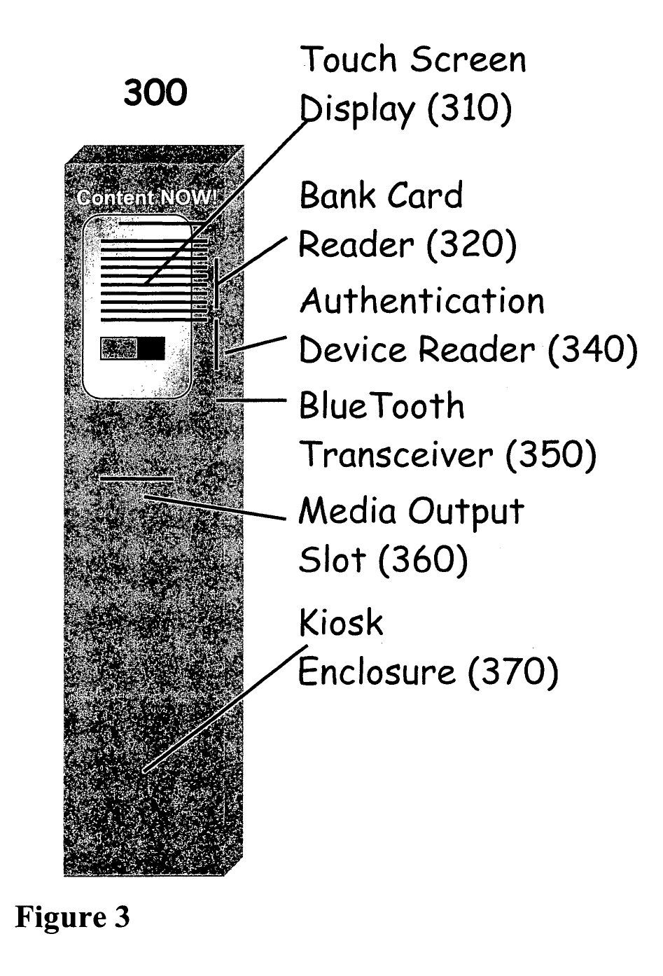

Referring to FIG. 3, some embodiments may involve interaction with a point-of-sale device (300). The point-of-sale device (300) may communicate with the content vendor (500) to display the menu of available content (700) and allow the user (400) to select content (700) to purchase, thus functioning as a mediator between the content provider (500) and the content purchaser (400). The point-of-sale device (300) may also communicate with the smart chip/card (100) by physically or wirelessly connecting to the authentication device (200), and may store content files (710) on the customer's memory card or burn them to an optical disk (or other memory means) for an additional ‘media charge’.

Other point-of-sale options may include mobile handsets, Personal Digital Assistants (PDAs) and desktop computers. Preferred embodiments may have Internet connectivity, may support SSL for financial transactions, may support either a physical or wireless connection to the authentication device (200) and should be able to download and store encrypted content files (710) on embedded or removable media, or the equivalent thereof. Evolving technology may serve to make the process even more streamlined.

The consumer (400) may interact with a point-of-sale (300) and select the content (700) that they want. The point-of-sale (300) may capture and validate the content (700) selections and the consumer billing information. The point-of-sale device (300) may take the user's payment for the content (700) using money or electronic means, such as a credit card number. This transaction may be anonymous or the user (i.e., the licensee) could provide personal account information. The more information provided by the user, the less anonymous the process becomes.

The point-of-sale (300) may transmit the content (700) request to the content provider (500) and transmit the user's public key to the content provider (500) so that the content provider (500) can encrypt the content (700) and download or write the content (700) to one of more mediums. The point-of-sale (300) may then transmit the content provider's (500) public key to the authentication device (200). The user's smart chip/card (100) may then encrypt its public key with the content provider's public key. Only the content provider (500) may decrypt the encrypted content file (710) by using its own private key, so the point-of-sale device (300) itself never has to utilize the user's public and private and key (120) information. The user's key information is transmitted back to the content provider (500).

The content provider (500) may then take the user's public and private key (120) information and decrypt the public key for the user (400). The content provider (500) may also validate the smart chip/card certificate to verify that the smart chip/card has not been hacked or interfered with. Then, the content provider (500) may randomly generate a key for the content (700) and encrypt the random content key using the user's public key such that only the smart chip/card's (100) private key can decrypt the content key. Then, the content provider (500) may encrypt the content (700) with the content key to essentially assemble an output file and transmit that file back to the point-of-sale device (300). The point-of-sale (300) will then store the content file (710) on whatever medium the customer (400) chooses, including, but not limited to, a memory card, a CD, a DVD, or a hard drive. The process is completed when the user (400) has an encrypted content file (710) that may be decrypted and played on a playback device (600) when the proper authentication device is within range. The point-of-sale device (300) may then perform a billing transaction upon completion of the process.

Again, the smart chip/card (100) may contain no personal information and be selected at random by the consumer (400). For example, a vendor may have authentication devices (200) available for sale and a user (400) may arbitrarily select a particular device (200), which may contain a smart chip/card (100). The consumer (400) could also use multiple smart chips/cards (100) so that content (700) purchased across them may not be linked by content providers (500). Additionally, each smart chip/card's (100) public key does not ever have to be transmitted in clear text, therefore the point-of-sale device (300) (or equivalent thereof) may never be able to associate a user (400) with his or her content (700) purchases.

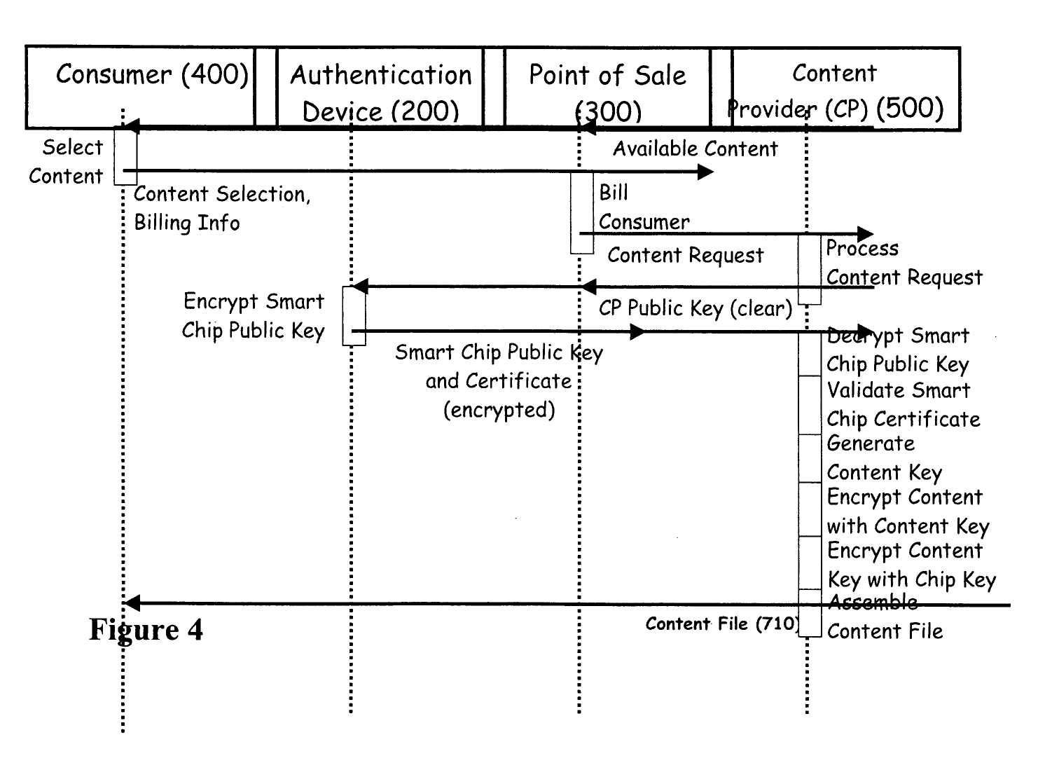

Referring to FIG. 4, in one embodiment, suppose a consumer (400) has a working authentication device (200) containing a working smart chip/card (100). The consumer (400) may interact with a point-of-sale (300) and select the content (700) they want. The point-of-sale (300) may capture and validate content (700) selection and consumer billing information. The point-of-sale (300) may also transmit the content (700) request to the content provider (500). The content provider (500) may transmit its public key to the point-of-sale (300). The point-of-sale (300) may transmit content provider's public key to consumer's authentication device (200). The smart chip/card (100) may then encrypt its public key and certificate with content provider's public key. The authentication device (200) may transmit the encrypted information to the point-of-sale (300). The point-of-sale (300) may transmit the encrypted information to the content provider (500). The content provider (500) may use its private key to decrypt the smart chip/card's (100) public key and certificate. The content provider (500) may validate the smart chip/card's certificate to ensure against chip/card hacking.

The content provider (500) may encrypt the content (700) using a randomly generated content key. The content provider (500) may also encrypt the content key using the smart chip/card's (100) public key. The content provider (500) may assemble the content file (710) from encrypted content plus other information. The content provider (500) may transmit the content file (710) to a point-of-sale device (300). The point-of-sale (300) may transmit the content file (710) to the consumer (400) via a memory card or other medium. The point-of-sale (300) may perform a billing transaction (e.g., credit card charge, record to billing system) to secure payment for the digital content (700). After payment has been processed, the consumer (400) has an encrypted digital content file (710).

The method, system, and apparatus protect digital media through content encryption. In some embodiments, however, the processing cost of decryption may be reduced because it may not be necessary to encrypt all of the content (700). Conversely, the first section of the content (700) may be encrypted, and some part of this and every other encrypted section may contain the relative offset and length of the next encrypted section. This creates a ‘random encryption’ that is hard to break. The percentage of the content (700) encrypted may be dynamically adjustable and may vary with content type.

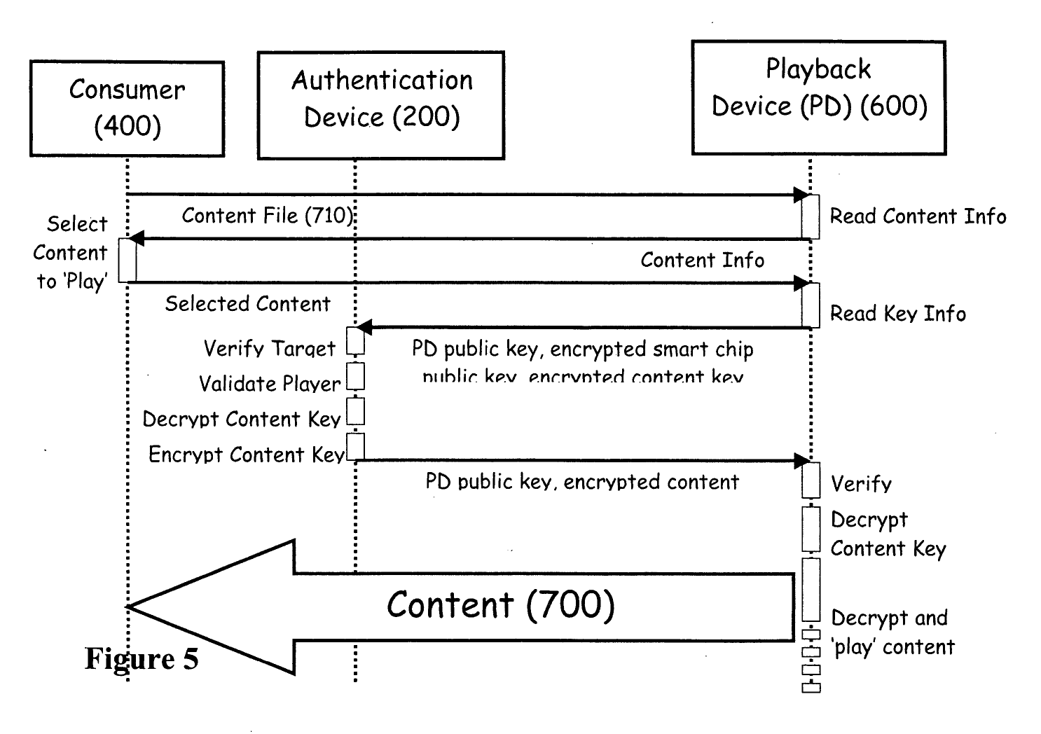

Referring to FIG. 5, in another embodiment, assume that a consumer has a working authentication device (200) containing a working smart chip/card (100) and that consumer has a valid encrypted content file (710) and wants to playback content (700).

The consumer (400) may transmit the content file (710) to a playback device (600) using some medium. The playback device (600) may read content information and display available content (700) to the consumer (400). The consumer (400) may select content (700) to play. The playback device (600) may read the encrypted smart chip/card public key and content key from the content file (710). The playback device (600) may transmit its public key and the encrypted smart chip/card public key and content key. The authentication device (200) may receive transmission and determine if it is the intended recipient by decrypting the transmission using its smart chip/card's private key and matching the transmitted smart chip/card public key against its own smart chip/card's public key. If the keys match, then the authentication device (200) may invoke a playback device (600) verification mechanism on the smart chip/card (100) to see if this playback device's public key is on file (to ensure against player hacking).

If the playback device's (600) public key is on file, then the authentication device (200) may invoke a decrypt function (140) on the chip/card (100) to decrypt the encrypted content key using the smart chip/card's private key. If decryption is successful, the smart chip/card (100) may encrypt the content key with the playback device's public key. The authentication device (200) may transmit the playback device's public key and the encrypted content key. The playback device (600) may receive the transmission and determine if it is the intended recipient by matching the transmitted user public key against its public key. If the keys match, then the playback device (600) may attempt to decrypt the content key with its private key. If decryption is successful, then the playback device (600) may decrypt the content (700) using the content key. The result is that the consumer (400) may receive access to the content (700).

The playback device (600) may read the content information and show it to the user (400). This may be the information that is not encrypted at the beginning of the file describing the contents contained therein (i.e., the preamble). The user (400) may select the content (700) he or she wants to play and the encrypted file for the selected content (710) may go back to the playback device (600). The playback device (600) may then read the key information off of the content file (710). Then, it may correspond with the authentication device (200) and may verify that it is the proper authentication device (200) for the particular content (700). For example, if there were multiple authentication devices (200) all sitting in a room, the playback device (600) could be programmed to identify the appropriate one. Coding this type of “handshake” is well within the abilities of those in the art. This may prevent a hacker from creating an artificial user (e.g., a software application) to trick the authentication device (200) into revealing its key information for the content (700).

The authentication device (200) may decrypt the content key and then re-encrypt the content key with the user's public key. The encrypted content key would be returned to the playback device (600). Thus, only that playback device (600) could decrypt the content file (710) and the content key would never be transmitted in clear text. The playback device (600) may then verify its information, decrypt the content file (710) using the encrypted content key (i.e., the decrypted content key that it's going to get), and then play back the content (700).

One feature of the system, method, and apparatus is that the playback device (600) may be trusted not to divulge the decrypted content (700). In order to do this, each playback device (600) vendor may be assigned a unique identification with a known public key. The system could then be configured to only trust known playback device (600) vendors. The playback device vendors may be further required to pass security tests and sign agreements guaranteeing compliance.

Valid playback device public keys may be stored on the smart chip/card (100). New keys may be added over time as needed, but may be provided only from the chip/card manufacturer encrypted by the manufacturer's private key or associated entity. In future embodiments, greater sharing and flexibility may be achieved while still maintaining the integrity of the embodiments described herein. Whether the playback device (600) is hardware or software, the manufacturer's private key encoded within should be as ‘hacker-proof’ as possible.

Various embodiments envision cooperation among entities. For instance, the content providers (500) should trust smart chip/card (100) manufacturers to ensure that smart chips/cards (100) cannot be hacked or simulated, and to ensure only trusted users are permitted. The content providers (500) must trust user manufacturers to ensure decrypted content (700) is not stored or otherwise accessible in digital form.

Valid playback device public keys may be stored on the smart chip/card (100). As new playback device (600) vendors are approved; their public key files are encrypted with the chip/card manufacturer's private key, and may be downloaded from the manufacturer's web site. The smart chip/card (100) may provide an ‘add player’ function that takes the playback device (600) key file, decrypts it using the manufacturer's public key, and stores it in memory. This may prevent hacking because hackers would have to know the chip/card manufacturer's private key to create a file with their own user's public key.

To further protect against hacking of a chip/card (100) or software simulation of a chip/card, each chip/card (100) may contain a digital certificate provided by the chip/card manufacturer and backed by a known certificate authority (e.g., VeriSign). The content provider (500) may validate the certificate when content is requested to prove that the chip/card (100) is indeed a valid chip/card (100) and not a hacked or simulated chip/card (100). The chip/card (100) may use security to ensure that the private key is never divulged or exposed.

The consumer (400) may lose all access to purchased content (700) if their chip/card (100) is lost or damaged. The smart chip/card (100) manufacturer may hold all smart chip/card serial numbers and key sets in escrow to ensure its ability to deliver a replacement chip/card. The smart chip/card serial number may be provided to the consumer (400). The consumer (400) may therefore return a damaged chip/card to the manufacturer for a replacement. If the chip/card (100) is lost, then the consumer (400) may request a replacement based on the serial number that was provided with the chip/card. Issuance of replacements should, however, be limited because the user is unknown and there is a possibility that the user is just asking for another copy to illegally share content

In extensions of the technology, the device may be used for other authentication functions outside of the DRM realm. Using the principles described herein, the device may, for example, be set up to authenticate a cellular phone or to authenticate the use of a device rather than access to a content. It may further be modified to almost anything one wants to play or use. In another instance, it may be keyed to a smart lock in a user's front door or car door. When the user approaches, the door may recognize the user and unlock the door.

In summary, numerous benefits have been described which result from employing the concepts of the invention. The foregoing description of an exemplary preferred embodiment to the invention has been presented for the purpose of illustration and description. It is not intended to be exhaustive or to limit the invention to the precise form disclosed. Obvious modifications or variations are possible in light of the above teachings. The embodiment was selected and described in order to best illustrate the principles of the invention and its principal application to hereby enable one of ordinary skill in the art to best utilize the invention in various embodiments and with various modifications as are suited to the particular use contemplated. It is intended that the scope of the invention be defined by the claims appended hereto.

1. A system for securing digital content comprising:
a. a smart chip;
b. an authentication device;
c. a playback device; and
d. an encrypted content file;
wherein
said smart chip holds a set of personal encryption keys, including a public key and a private key;
said encrypted content file is at least partially encrypted with said public key included in said set of personal encryption keys;
said authentication device is configured to:
hold said smart chip; and
permit said smart chip to interface with said playback device; and
said playback device is configured to:
receive said encrypted content file;
detect said authentication device;
electronically communicate with said smart chip, within a predefined communication range;
decrypt said encrypted content file using said private key; and
play said content file on said playback device.

2. A system as claimed in claim 1, wherein said encrypted content file comprises digital content, said digital content comprising a work encoded in digital form.

3. A system as claimed in claim 2, wherein said digital content is selected from literature, music, software applications static images, video, and combinations thereof.

4. A system as claimed in claim 1, wherein said smart chip comprises a digital certificate.

5. A system as claimed in claim 4, wherein a content provider may authorize said smart chip by validating said digital certificate.

6. A system as claimed in claim 1, wherein said authentication device is a portable device.

7. A system as claimed in claim 6, wherein said playback device is further configured to verify the proximity of a user by determining whether said authentication device is within said predefined communication range.

8. A system as claimed in claim 1, wherein said encrypted content file may be written to a plurality of mediums.

9. A system as claimed in claim 8, wherein said plurality of mediums is selected from compact discs, digital video discs, memory sticks, memory cards, hard disks, hard drives, and combinations thereof.

10. A system as claimed in claim 1, wherein said encrypted content file may be received and played by a plurality of playback devices.

11. A system as claimed in claim 1, further comprising a point-of-sale device, wherein said authentication device is configured to permit said smart chip to interface with said point-of-sale device.

12. A system for securing digital content comprising:
a. a smart chip;
b. an authentication device;
c. a playback device;
d. an encrypted content file; and
e. a point-of-sale device
wherein
said smart chip holds a set of personal encryption keys, including a public key and a private key;
said encrypted content file is at least partially encrypted with said public key included in said set of personal encryption keys;
said authentication device is configured to:
hold said smart chip;
permit said smart chip to interface with said playback device and said point-of-sale device; and
said playback device is configured to:
receive said encrypted content file;
detect said authentication device;
electronically communicate with said smart chip, within a predefined communication range;
decrypt said encrypted content file using said private key; and
play said content file on said playback device.

13. A method for securely distributing and using digital content comprising the steps of:
a. inserting a smart chip including a public key and a private key into an authentication device, wherein said authentication device is configured to permit said smart chip to interface with a playback device;
b. creating an encrypted content file by encrypting a piece of digital content with a random content key;
c. encrypting said random content key with said smart chip's public key such that said random content key may only be decrypted by said smart chip's private key; and
d. configuring said playback device to communicate with said authentication device to decrypt said encrypted content file.

14. A method as claimed in claim 13, wherein said random content key is an automatically generated string of random letters and numbers.

15. A method as claimed in claim 13, further comprising the steps of configuring said playback device to:
a. electronically communicate with said smart chip within a predefined communication range; and
b. verify the proximity of a user by determining whether said authentication device is within said predefined communication range.

16. A method for effecting secure purchase and use of digital content comprising the steps of:
a. inserting a smart chip including a public key and a private key into an authentication device, wherein said authentication device is configured to permit said smart chip to interface with a playback device;
b. allowing a user possessing said smart chip to interact with a point-of-sale device and select a piece of digital content;
c. configuring said point-of-sale device to transmit said user's selection to a content provider;
d. said content provider encrypting said piece of digital content with a random content key and encrypting said random content key with said smart card's public key such that said random content key may only be decrypted by said smart card's private key; and
e. storing said piece of digital content on a storage medium.

17. A method as claimed in claim 16, wherein said smart chip comprises a digital certificate.

18. A method as claimed in claim 17, further comprising the step of said content provider authorizing said smart chip by validating said digital certificate.

19. A computer readable medium having computer executable instructions for performing a method comprising:
a. initiating communication between an authentication device and a playback device having a set of personal encryption keys, including a public key and a private key;
b. configuring said authentication device to decrypt a random content key and re-encrypt said random content key with said public key;
c. configuring said playback device to decrypt said random content key with said private key and use said random content key to decrypt an encrypted content file.
